(19) United States
(12) Patent Application Publication
(10) Pub. No.: US 2005/0156395 A1
(43) Pub. Date: Jul. 21, 2005

(54) Rolling walker with arm rest platforms

(76) Inventor: David L. Bohn, Anderson, SC (US)

Correspondence Address: ROBERT R. REED;Patent Consultants & Services, Inc., 204 Bouchillion Drive, Greenville, SC, 29615, US

(21) Appl. No.: 10/760,908

(22) Filed: Jan. 20, 2004

(51) Int. Cl. B62M 1/00

(52) U.S. Cl. 280/87.021

(57) ABSTRACT

The present invention provides a pair of arm rest platforms and vertical handles so the user of a rolling walker can have added or alternate support not provided by a conventional rolling walker or rollator. The arm rest platforms are supported at a vertical distance above the conventional walker by providing a pair of arm rest frames each extending between the main frame of the conventional walker and a respective arm rest platform. The arm rest frames each includes an main arm rest frame member carried by the main frame of the conventional walker and an arm rest support member to carry the arm rest platform and vertical handles. The conventional hand brakes can also be relocated; to be operated when gripping the vertical handles. The arm rest platforms can be adjusted in both horizontally and vertically with respect to the main frame of the conventional walker for better distribution of the user's weight.

### BACKGROUND OF THE INVENTION

This invention is directed to walkers to assist medical patients in walking and more particularly to a 4-wheeled rolling walker having horizontal handles with hand brakes made for strolling outdoors, and having a seat for periodic periods of rest or for transporting the patient when seated.

There are a number of conventional walkers that combine a light weight folding frame that is easy to lift and store and perfect for strolling outdoors. They include four wheels of relatively small size (i.e. six inch diameter) with two wheels having a hand brake assembly. A seat with a backrest is provided so the user can set the handbrake and take a rest. A basket may also be provided under the seat for shopping and/or to carry personal items as the user grips the horizontal handles that assist them in walking. The user controls the movement of the walker by gripping the horizontal handles and steering the conventional walker by pushing or pulling one handle relative to the other handle. Support for the user's weight is provided through the strength they have through their wrists. Conventional walkers having four wheels, horizontal handles and a seat and/or a shopping basket typical of the industry are-disclosed in U.S. Pat. Nos.: 5,772,234; 6,099,002; 6,311,708; 6,318,392; and 6,494,469. The conventional walker used as a prior art walker for making the generic improvements disclosed in the present invention is the model 4202 Cruiser Deluxe Rollator manufactured by Nova.

The conventional rolling walker or “rollator” with horizontal handles provides little support for users not strong enough to fully support their own weight. The user is generally in a stooped position when gripping the horizontal handles, which is not very comfortable, and sometimes not possible for anyone having back problems. The conventional walker is also positioned well ahead of the user; causing limited room for maneuvering the walker in a space limited environment, such as a bathroom or toilet area.

A need exists to have an improved walker where the weight of the user/patient is better distributed for increased support and stability of the conventional walker during use. The patient's forearm can be made to rest on a support or arm rest platform. The user would, therefore, be able to stand more erect with more weight supported directly by the walker so that the patient's back is not being strained. A pair of vertical handles are needed for steering the walker with the forearms resting on the platform. Patients not yet strong enough to operate and maneuver the conventional four wheeled walker should be able to use the improved or platform walker until such a time that the conventional walker is the appropriate one to use. The improvements to the conventional walker need to be provided as an aftermarket device.

Platforms used on walkers to support forearms are disclosed in U.S. Pat. Nos.: 3,625,237; 4,248,256; 4,510,956; 5,567,783; and 6,279,591. Generally speaking these references do not include all the essential features of providing support for both forearms, providing vertical handles for steering the walker and providing an aftermarket device for the conventional four wheeled walker with horizontal handles.

Accordingly, an object of the present invention is to provide a walker that allows the user to stand erect to steer the walker and distribute part of their weight on the walker as they move from place to place with the aid of the walker.

An essential object of the present invention is to provide additional structural components added to a conventional walker to include additional arm rest platforms and vertical handles that adjust horizontally and vertically to best support the user's weight and provide better steering control.

A further object of the present invention is to provide a walker that has a pair of handles to allow the user to be transported from place to place with the user facing in a forward direction; as in a wheel chair.

Another object of the present invention is to provide an arm rest assembly that can be folded or removed for transporting the folded walker when it is not being used.

Yet another object of the present invention is to provide structural components that allow the walker to be used as a conventional walker or converted to platform walker.

One additional object of the present invention is to provide an arm rest assembly that can be used as an aftermarket device for the conventional walker.

### SUMMARY OF THE INVENTION

The above objectives are accomplished according to the present invention by providing a pair of arm rest platforms and vertical handles so the user of a rolling walker can have added or alternate support not provided by a conventional rolling walker or rollator. The arm rest platforms are supported at a vertical distance above the conventional walker by providing a pair of arm rest frames each extending between the main frame of the conventional walker and a respective arm rest platform. The arm rest frames each includes an main arm rest frame member carried by the main frame and an arm rest support member to carry the arm rest platform and vertical handles. The conventional hand brakes can also be relocated to be operated when gripping the vertical handles. The arm rest platforms can be adjusted in both horizontally and vertically with respect to the main frame of the conventional walker for better distribution of the user's weight.

In one embodiment of the invention, an improvement is provided in a conventional walker having four wheels, a main frame, a pair of horizontal handles each with a hand brake assembly operating two of the four wheels, a back rest member and a seat for a user to sit and rest when not walking. The improvement comprises a pair of arm rest frames each having a main arm rest frame member with an aperture near a bottom end. An arm rest support member is affixed at an upper end of each main arm rest frame member. A pair of arm rest support assemblies are each affixed to the main frame of the conventional walker to adjustably receive and support a respective arm rest frame so that the arm rest support members are essentially horizontally disposed at a vertical distance above the horizontal handles. An arm rest platform is adjustably attached to each arm rest platform support at a horizontal location to help support the user's weight. A pair of essentially vertically disposed handles are each affixed to a respective arm rest support member. The conventional walker also becomes a “platform walker” and the user can optionally stand more erect to distribute some additional weight on said arm rest platforms and grip said vertical handles to better steer the platform walker.

In another embodiment of the invention, an arm rest assembly in combination with a conventional four wheeled rolling walker provides improved ambulatory assistance to a user. The combination comprises a conventional walker having four wheels, a main frame, a pair of horizontal handles each with a hand brake assembly operating two of the four wheels and a seat with a back rest for providing basic ambulatory assistance to the user A pair of arm rest frames are provided with each rest frame having a main arm rest frame member with an aperture near a bottom end. An arm rest support member is affixed at an upper end of each main arm rest frame member. A pair of arm rest support assemblies of the main frame are provided to adjustably receive and support a respective arm rest frame so that the arm rest support members are essentially horizontally disposed at a vertical distance above the horizontal handles. An arm rest platform is adjustably attached to each arm rest support member at a horizontal location to help support the user's weight. A pair of essentially vertically disposed handles are each affixed to a respective arm rest support member. The arm rest platforms and the handles provide improved ambulatory assistance to the user.

In a further embodiment of the invention, a rolling walker provides ambulatory assistance to a user. The rolling walker comprises a main frame including main frame front legs and main frame rear legs supported on four wheels so that the main frame can be folded for storage and transporting from place to place. A seat with a back rest provides basic support for the user during periods of rest. A pair of arm rest frames are provided with each arm rest frame having a main arm rest frame member with an aperture near a lower end. An arm rest support member is affixed at an upper end of each main arm rest frame member. A pair of height adjustment assemblies of the main frame are provided to adjustably receive and support a respective arm rest frame so that the arm rest support members are essentially horizontally disposed at a vertical location above a ground surface. An arm rest platform is adjustably attached to each arm rest support member at a horizontal location to help support the user's weight. A pair of essentially vertically disposed handles are each affixed to a respective arm rest support member. The arm rest platforms and said handles provide improved ambulatory assistance to the user. A hand brake associated with each vertical handle is operated by the user to stop two of the four wheels from rotating.

### DESCRIPTION OF THE DRAWINGS

The construction designed to carry out the invention will hereinafter be described, together with other features thereof.

The invention will be more readily understood from a reading of the following specification and by reference to the accompanying drawings forming a part thereof, wherein an example of the invention is shown and wherein:

FIG. 1 is a perspective view of a conventional rolling walker known in the art and having four wheels, a seat with a backrest and horizontal handles with hand brakes for operating the walker;

FIG. 2 is a perspective view of a modified conventional walker or platform walker according to the present invention having the additions of arm rest platforms for better support of the user and vertical handles for increased steering control when operating the walker;

FIG. 3 is an enlarged perspective view illustrating connection details for the additional structural components of the platform walker of the invention added at one lateral side to the conventional walker including height adjustment devices and other platform support components;

FIG. 4 is an exploded perspective view of the added structure and adjustment features of the platform walker of this invention which are used to convert the conventional walker into a platform walker;

FIG. 4A is a cross-sectional view of the arm rest assembly taken along line A-A in FIG. 3; and

FIG. 5 is an enlarged perspective view illustrating connection details for the additional structural components of the platform walker that have replaced the horizontal handle and hand break assembly of the conventional walker

### DESCRIPTION OF A PREFERRED EMBODIMENT

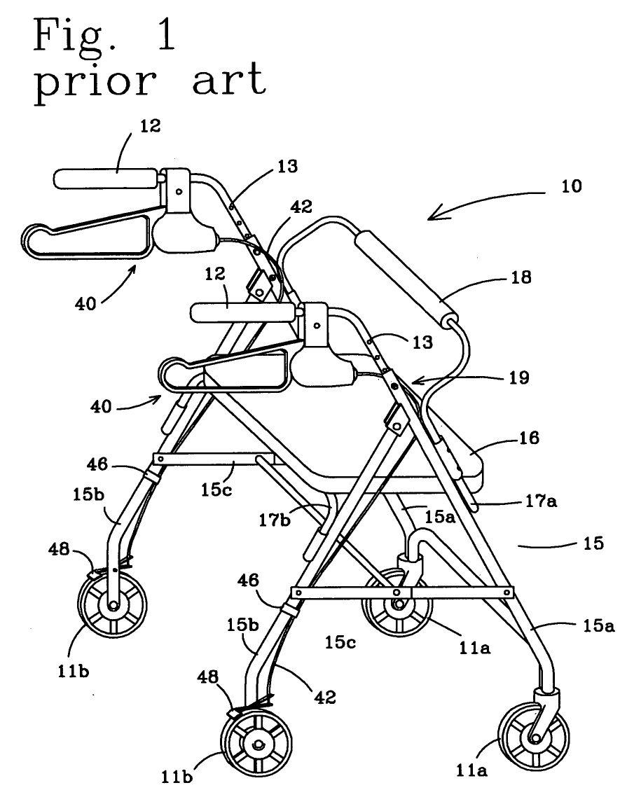

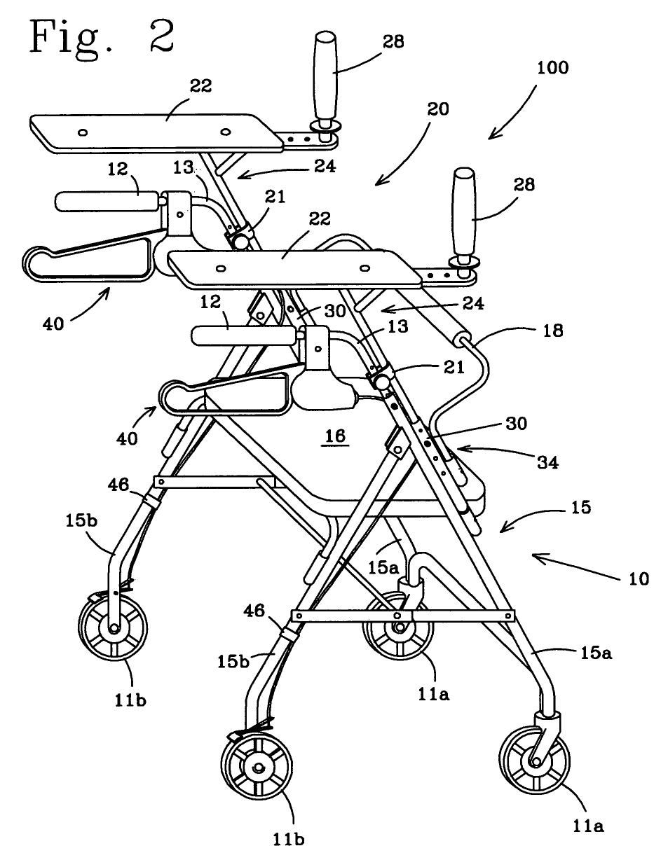

Referring now in more detail to the drawings, the invention will now be described in more detail. A conventional four wheeled rolling walker, known in the art as a “rollator” walker 10, is illustrated in FIG. 1. This conventional walker has been modified to include arm rest platforms 22 to provide a “platform walker” 100, as illustrated in FIG. 2. The conventional walker includes a folding main frame 15, and a pair of horizontal handles 12 each supported by a handle frame 13 attached to the main frame with a main height adjustment device 19. The main frame includes a pair of main frame front legs 15a, a pair of main frame rear legs 15b and a rear leg pivot device 14 so that the main frame folds for storage and transporting from place to place. A pair of main frame braces 15c maintains the conventional walker in a deployed configuration. Two rear wheels of the four wheels operate as breaking wheels 11b and two front wheels operate as castered wheels 11a. A hand brake 40 adjacent each horizontal handle is associated through a brake cable 42 to operate wheel brakes 48 of the two rear breaking wheels and stop the walker from rolling. A basket may also be provided under the seat for shopping and/or to carry personal items as the user grips the horizontal handles that assist them in walking.

The user of conventional rolling walker 10 grips horizontal handles 12 and steers the walker by pushing or pulling on respective handles as needed. The conventional walker is also designed to provide a place for the user to sit and rest as needed or desired. A seat 16 is supported from main frame 15 by a front seat support 17a and a rear seat support 17b. A backrest member 18 connected with the main frame to support the user's back when the user is setting down.

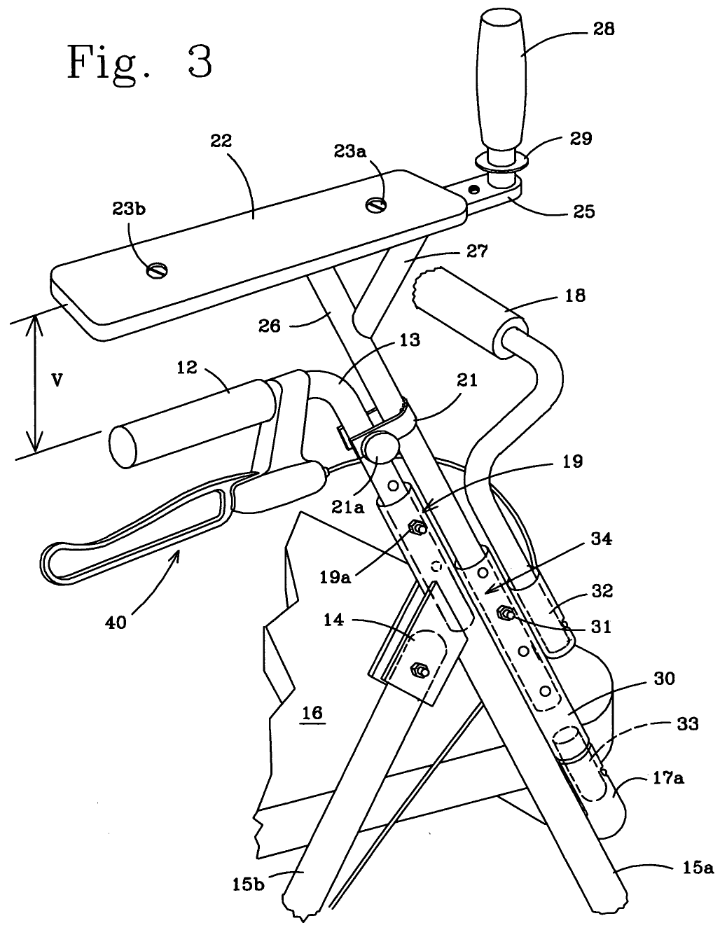

The improvements to the conventional rolling walker of this invention, as illustrated in FIGS. 2 and 3, result in a “platform walker” 100. The improvements include two arm rest platforms 22 each supported by an arm rest frame 24 connected to main frame 15 by an arm rest support assembly 34. Hand brake assembly 40 remains attached to the handle frame with this preferred embodiment. The arm rest support assembly includes an arm rest sleeve 30 with a center aperture 30a. The arm rest sleeve is affixed to a main frame front leg 15a to receive main arm rest frame member 26. A height adjustment fastener 31 is installed to establish the vertical distance “V” of the arm rest platform above horizontal handle 12. Alternatively, the height adjustment fastener can be a spring loaded button mounted in the main arm rest frame member to extend through a selected aperture in the arm rest sleeve to establish the vertical distance.

The effectiveness of the platform walker depends on the selection of a proper height of the arm rest platforms to prevent the user from slouching and putting extra stress on the back and forearms. The vertical distance is critical in establishing the proper height of the arm rest platform to support a user at an optimum height for each particular user. The vertical distance is commonly in a range of three to four inches to assist the user in standing more erect when using the platform walker. Overall height of the arm rest platform from a ground surface is normally in a range of about thirty three inches to about thirty seven inches. For a properly adjusted platform walker the distribution of the user's weight on the walker is slightly forward of the center of the wheels closer to the castered front wheels to increase stability and maneuverability of the platform walker. In another aspect of the invention, the arm rest platforms are made with a contour and padded to provide additional comfort for the forearms of the user.

The arm rest support assembly further includes a support strap 21 with a support strap fastener 21a to attach the main arm rest frame member to handle frame 13. An aperture can be drilled in the handle frame to receive the strap fastener. A main height adjustment assembly 19 with fastener 19a allows the horizontal handle to be height adjusted independent of the height of the arm rest platform. A back rest sleeve 32 is affixed to arm rest sleeve 30 to allow back rest member 18 to be relocated. Front seat support 15a is made to fit center aperture 30a of the arm rest sleeve to help support seat 16.

A vertical handle 28 is attached to arm rest support member 25. When the forearms of the user are placed on the arm rest platforms, the user grips the vertical handles above a grip stop 29 to steer the platform walker from place to place. Control of the platform and support for the user is more positive with the use of both the forearms and the hands. Users having back problems can receive more support from using the vertical handles and the arm rest platforms. A horizontal adjustment in the location of the arm rest platforms is provided by arm rest attachments 23a. The arm rest platform attaches to arm rest support member 25 at different locations to best locate the center of gravity of the user with respect to the center of contact of the four wheels.

In one important aspect of platform walker 100, the user may be transported from place to place when facing forward. That is, a third party using the vertical handles to push the user about when seated, actually reverses the direction of travel from the conventional walker. This direction of travel is the common and familiar direction for a wheelchair and the like The braking and castered wheels can be reversed if the steering of the walker become awkward.

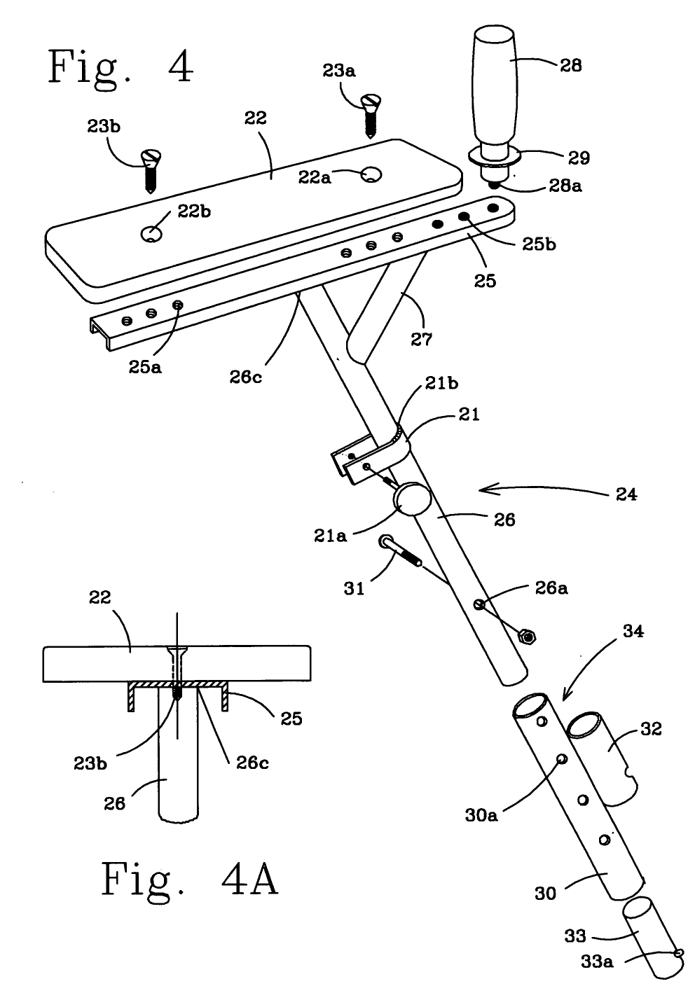

An exploded view of the components of arm rest assembly 20 added to conventional walker 10 to provide platform walker 100 is shown in FIG. 4. Each arm rest frame 24 includes main arm rest frame member 26, brace 27 and arm rest support member 25. The arm rest support member is affixed to an upper end of the main arm rest frame member. The arm rest support member has a series of threaded apertures 25a to receive arm rest attachments 23a and 23b for adjustably attaching arm rest platform 22 to the arm rest support member and threaded apertures 25b for adjustably attaching vertical handle 28 to the arm rest support member, see FIG. 4A. A frame aperture 26a near the lower end of the main arm rest frame member is used to attach the main arm rest frame member to arm rest sleeve 30. The arm rest sleeve is affixed to the conventional walker (not shown) for supporting the arm rest frame of arm rest assembly 20. Spaced apart sleeve aperture pairs 30a are selectively aligned with frame aperture 26a and height adjustment fastener 31 is placed through a predetermined aperture pair and the frame aperture to locate each arm rest platform to provide platform walker 100. A seat sleeve 33 is welded to the bottom end of arm rest sleeve 30 and includes a spring latch 33a to secure rear seat support 17a attached to the seat sleeve. Support strap 21 with support strap fastener 21a are used to attach the arm rest assembly to the handle frame (not shown) of the conventional walker. Preferably the support strap is attached to the handle frame using a weld 21b to obtain a more rigid attachment.

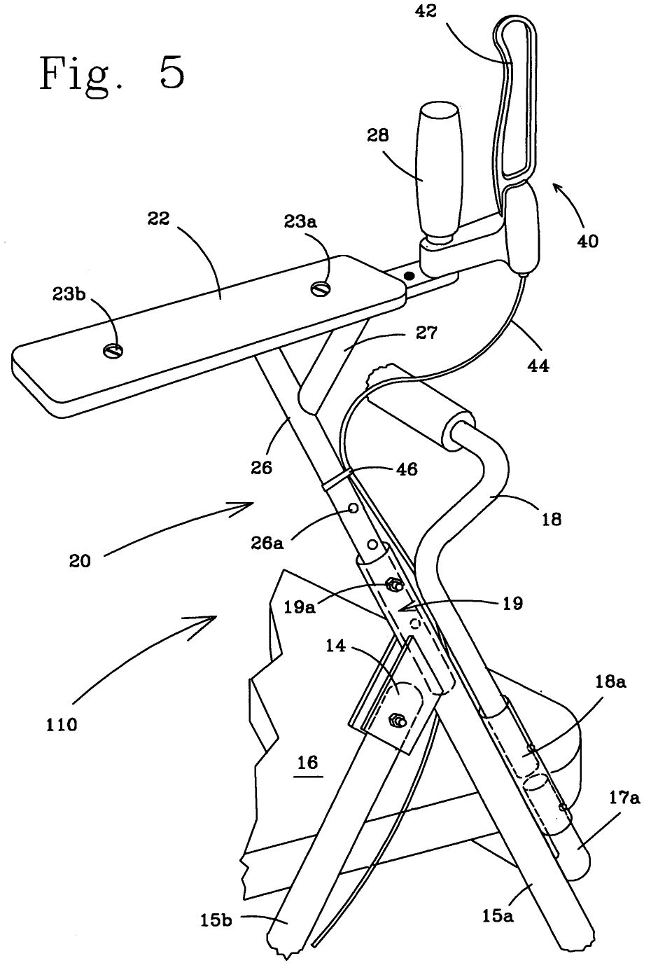

In another embodiment of the present invention, arm rest assemblies 20 replace horizontal handles 12 and handle frames 13 to provide a platform walker 110, as illustrated in FIG. 5. Platform walker 110 of this embodiment does not provide the horizontal handles of the conventional rolling walker of FIG. 1. The handle frame and horizontal handles have been removed from main height adjustment assembly 19 and main arm rest frame member 26 is inserted inside main frame front leg 15a. A fastener 19a of the height adjustment assembly holds the main arm rest frame member within main frame front leg 15a. Additional apertures 26a are provided in the main arm rest frame member to allow for a height adjustment. The same adjustment in the height of the arm rest platforms is provide as previously provided for the horizontal handles with the conventional walker. A back rest and seat support sleeve 18a provides support for backrest member 18 and rear seat support 17a of seat 16. This is essentially the same support sleeve used with the conventional walker of FIG. 1. Generally speaking, spring latches can be used to hold the backrest member and the rear seat support within the support sleeve. The main frame includes a pair of main frame front legs 15a, a pair of main frame rear legs 15b and a rear leg pivot device 14 so that the main frame folds for storage and transporting from place to place.

Each hand brake 40 has been relocated to provide a hand brake 42 when gripping a respective vertical handle 28. The relocation of the hand brakes can also be made with the platform walker configuration of FIG. 2. The location of the hand brake may be located either with the horizontal handles or the vertical handles depending on the best location for each individual user.

The rolling walker can be used as a conventional walker or with the improvements of this invention to provide a platform walker or a combination conventional walker and platform walker. The arm rest assembly can be marketed as an aftermarket device to improve the conventional walker. In another aspect of the invention, each arm rest frame 24, arm rest platform 22, vertical handle 28 and arm rest sleeve 30 with arm rest support assembly 34 can be made as a single unit to attach to front leg 15a of conventional walker 10.

The four wheeled rolling walker or rollator used as a typical conventional walker known in the industry to include horizontal handles with hand brakes, a seat and a back rest is the “Nova 4202 Cruiser Deluxe Rollator” as illustrated in FIG. 1 and included as one of the references. The improvements or changes made to the conventional rolling walker in this invention provide arm rest platforms and vertical handles that can either be an addition to the conventional walker or replace the horizontal handles and handle frames of the conventional walker. Other similar makes and models of conventional rolling walkers having horizontal handles are known in the industry, manufactured and sold commercially. Manufacturers include Invacare, Dolomite, Guardian and Winmed. The structural components of this invention can be made for other similar four wheeled rolling walkers to provide the same ambulatory improvements in the support of the user with the addition of arm rest platforms and vertical handles. While a preferred embodiment of the invention has been described. using specific. terms an a particular prior art reference, such description is for illustrative purposes only, and it is to be understood that changes and variations may be made without departing from the spirit or scope of the following claims.

1. An improvement in a conventional walker having four wheels, a main frame, a pair of horizontal handles each with a hand brake assembly operating two of the four wheels, a back rest member and a seat for a user to sit and rest when not walking, said improvement comprising:
a pair of arm rest frames each having a main arm rest frame member with an aperture near a bottom end;
an arm rest support member affixed at an upper end of said each main arm rest frame member;
a pair of arm rest support assemblies each affixed to the main frame of the conventional walker to adjustably receive and support a respective arm rest frame so that said arm rest support members are essentially horizontally disposed at a vertical distance above the horizontal handles;
an arm rest platform adjustably attached to each arm rest platform support at a horizontal location to help support the user's weight;
a pair of essentially vertically disposed handles each affixed to a respective arm rest support member, wherein the conventional walker also becomes a “platform walker” and the user can optionally stand more erect to distribute some additional weight on said arm rest platforms and grip said vertical handles to better steer said platform walker.

2. The improvement in a conventional walker of claim 1 wherein each one of said pair of arm rest support assemblies includes:
an arm rest sleeve having a center aperture to adjustably receive said main arm rest frame member and a series of lengthwise spaced apart aperture pairs, wherein said aperture of said main arm rest frame member and a respective aperture pair are aligned for adjusting and fixing the location of said main arm rest frame member within said center aperture of said arm rest sleeve.

3. The improvement in a conventional walker of claim 2 wherein each one of said pair of arm rest support assemblies includes:
a height adjustment fastener extending through said aperture of said main arm rest frame member and a respective aperture pair of said arm rest sleeve to adjustably establish a vertical distance of said arm rest platform above the horizontal handles.

4. The improvement in a conventional walker of claim 3 including a back rest sleeve affixed to said arm rest sleeve to receive and support the back rest of the conventional walker.

5. The improvement in a conventional walker of claim 1 wherein each one of said pair of arm rest frames includes a diagonal brace extending between said main arm rest member and said arm rest support member to add strength to said each arm rest frame.

6. The improvement in a conventional walker of claim 1 including a support strap with a support strap fastener for attaching said arm rest frame to the main frame of the conventional walker.

7. The improvement in a conventional walker of claim 1 wherein each one of said pair or arm rest platforms includes a plurality of arm rest attachments to affix said arm rest platform to a respective arm rest support member so that said arm rest platform is horizontally adjusted with respect to a respective vertical handle.

8. The improvement in a conventional walker of claim 7 wherein said arm rest attachments are fasteners extending through apertures in said arm rest platform into a predetermined combination of threaded apertures of said support member to provide the horizontal adjustment.

9. The improvement in a conventional walker of claim 7 wherein said arm rest platforms are contoured and padded to provide additional comfort for the forearms of the user.

10. An arm rest assembly in combination with a conventional four wheeled rolling walker for providing improved ambulatory assistance to a user, said combination comprising:
a conventional walker having four wheels, a main frame, a pair of horizontal handles each with a hand brake assembly operating two of the four wheels and a seat with a back rest for providing basic ambulatory assistance to the user;
a pair of arm rest frames each having a main arm rest frame member with an aperture near a bottom end;
an arm rest support member affixed at an upper end of said each main arm rest frame member;
a pair of arm rest support assemblies of said main frame to adjustably receive and support a respective arm rest frame so that said arm rest support members are essentially horizontally disposed at a vertical distance above said horizontal handles;
an arm rest platform adjustably attached to each arm rest support member at a horizontal location to help support the user's weight;
a pair of essentially vertically disposed handles each affixed to a respective arm rest support member, wherein said arm rest platforms and said handles provide improved ambulatory assistance to the user.

11. The combination arm rest assembly and rolling walker of claim 10. wherein each one of said pair of arm rest support assemblies includes:
an arm rest sleeve having a center aperture, to adjustably receive said main arm rest frame member, and a series of lengthwise spaced apart aperture pairs, wherein said aperture of said main arm rest frame member and a respective aperture pair are used for adjusting and fixing the location of said main arm rest frame member within said center aperture of said arm rest sleeve.

12. The combination arm rest assembly and rolling walker of claim 10 wherein each one of said pair of arm rest support assemblies includes:
a height adjustment fastener extending through said aperture of said main arm rest frame member and a respective aperture pair of said arm rest sleeve to adjustably establish the location of said arm rest platform.

13. The combination arm rest assembly and rolling walker of claim 10 including a back rest sleeve affixed to said arm rest sleeve to receive and support said back rest of the conventional walker.

14. The combination arm rest assembly and rolling walker of claim 10 including a support strap with a support strap fastener for connecting said arm rest frame to the main frame of the conventional walker.

15. A rolling walker for providing ambulatory assistance to a user, said walker comprising:
a main frame including main frame front legs and main frame rear legs supported on four wheels so that said main frame can be folded for storage and transporting from place to place;
a seat with a back rest for providing basic support for the user during periods of rest;
a pair of arm rest frames each having a main arm rest frame member with an aperture near a lower end;
an arm rest support member affixed at an upper end of said each main arm rest frame member;
a pair of height adjustment assemblies of the main frame to adjustably receive and support a respective arm rest frame so that said arm rest support members are essentially horizontally disposed at a vertical location above a ground surface;
an arm rest platform adjustably attached to each arm rest support member at a horizontal location to help support the user's weight;
a pair of essentially vertically disposed handles each affixed to a respective arm rest support member, wherein said arm rest platforms and said handles provide improved ambulatory assistance to the user; and
a hand brake associated with each vertical handle operated by the user to stop two of said four wheels from rotating.

16. The rolling walker of claim 15 wherein each one of said pair of height adjustment assemblies includes:
a height adjustment fastener extending through the aperture of said main arm rest frame member and a respective aperture pair of said main frame front leg to adjustably establish a vertical distance of said arm rest platform above the ground surface.

17. The rolling walker of claim 15 wherein each one of said pair of arm rest frames includes a diagonal brace extending between said main arm rest member and said arm rest support member to add strength to said each arm rest frame.

18. The rolling walker of claim 15 wherein each one of said pair or arm rest platforms includes a plurality of arm rest attachments to affix said arm rest platform to a respective arm rest support member so that said arm rest platform is horizontally adjusted with respect to a respective vertical handle.
